(19) United States
(12) Patent Application Publication
(10) Pub. No.: US 2011/0272511 A1
(43) Pub. Date: Nov. 10, 2011

(54) Dust Reduction Mechanism in an Aggregate Removal System

(76) Inventors: David R. Hall, Provo, UT (US); Jeff Jepson, Spanish Fork, UT (US)

(21) Appl. No.: 13/102,827

(22) Filed: May 6, 2011

Related U.S. Application Data
(63) Continuation-in-part of application No. 12/888,200, filed on Sep. 22, 2010.
(60) Provisional application No. 61/332,128, filed on May 6, 2010.

(51) Int. Cl. B02C 19/00

(52) U.S. Cl. 241/101.2

(57) ABSTRACT

In one aspect of the invention, an aggregate removal system includes a self propelled vehicle with a frame and a conveyor. The conveyor has an intake end and an output end. A milling drum is connected to an underside of the frame and is enclosed within a milling chamber, which is defined by a front plate, side plates, and a moldboard. The drum is configured to drop aggregate within the milling chamber onto the intake end of the conveyor that protrudes into the milling chamber. The conveyor is configured to remove the aggregate from the milling chamber, and the conveyor also has at least one dust suppressant nozzle configured to apply a dust suppressant to aggregate carried by the conveyor.

### CROSS REFERENCE TO RELATED APPLICATIONS

This application is a continuation-in-part of U.S. patent application Ser. No. 12/888,200, which was filed on Sep. 22, 2010 and entitled Multiple Milling Drums Secured to the Underside of a Single Milling Machine. This application also claims priority to U.S. Provisional Patent Application Ser. No. 61/332,128 filed on May 6, 2010. Both of these applications are herein incorporated by reference for all that they disclose.

### BACKGROUND OF THE INVENTION

This invention deals with conveyor systems for removing aggregate from an excavating machine. Specifically, the invention deals with dust reduction in road milling machines.

### BRIEF SUMMARY OF THE INVENTION

In one aspect of the invention, an aggregate removal system includes a self propelled vehicle with a frame and a conveyor. The conveyor has an intake end and an output end. A milling drum is connected to an underside of the frame and is enclosed within a milling chamber, which is defined by a front plate, side plates, and a moldboard. The drum is configured to drop aggregate within the milling chamber onto the intake end of the conveyor that protrudes into the milling chamber through an opening. The conveyor is configured to remove the aggregate from the milling chamber, and the conveyor also has at least one dust suppressant nozzle configured to apply a dust suppressant to aggregate carried by the conveyor.

In some embodiments, the intake end of the conveyor is supported by the vehicle, and the output end is suspended in the air. The dust suppressant nozzle may be disposed proximate the intake end and/or the output end. The conveyor may also have a plurality of conveyor belts.

The dust suppressant nozzle may be a fogging or spray nozzle that is configured to direct dust suppressant onto aggregate carried by the conveyor. In other embodiments, the nozzle may be a foaming nozzle that is configured to foam the dust suppressant onto aggregate carried by the conveyor. An air compressor may be attached to the conveyor and be configured to mix air with the dust suppressant to form a foam before the dust suppressant exists the nozzle. In some embodiments, the foam will form a dust suppression blanket over the aggregate. The dust suppressant may have a half life that is at least as long as a duration between applying the dust suppressant to a piece of aggregate and ejecting the piece from the conveyor through the output end. However, the half life may be at least twice as long as that duration.

The conveyor may also comprise an enclosure that approximately extends or spans from the intake end to the output end. The nozzle may be incorporated into the enclosure. In some embodiments, the enclosure may also comprise at least one vacuum port configured to remove dust from within the enclosure. The vacuum port may be attached to a vacuum mechanism that is configured to direct dust back onto the conveyor or, in some cases, directly into a truck bed. Also, the enclosure may comprise a brush proximate the output end that is configured to direct aggregate off of an underside of a conveyor belt.

### BRIEF DESCRIPTION OF THE DRAWINGS

FIG. 1 is an orthogonal view of an embodiment of a self-propelled vehicle.

FIG. 2 is a cutaway view of an embodiment of a conveyor.

FIG. 3 is a cutaway view of another embodiment of a conveyor.

FIG. 4 is a cutaway view of another embodiment of a conveyor.

FIG. 5 is a perspective view of another embodiment of a conveyor.

FIG. 6 is an orthogonal view of another embodiment of a conveyor.

FIG. 7 is a cross sectional view of another embodiment of a conveyor.

FIG. 8 is an orthogonal view of another embodiment of a conveyor.

### DETAILED DESCRIPTION OF THE INVENTION AND THE PREFERRED EMBODIMENT

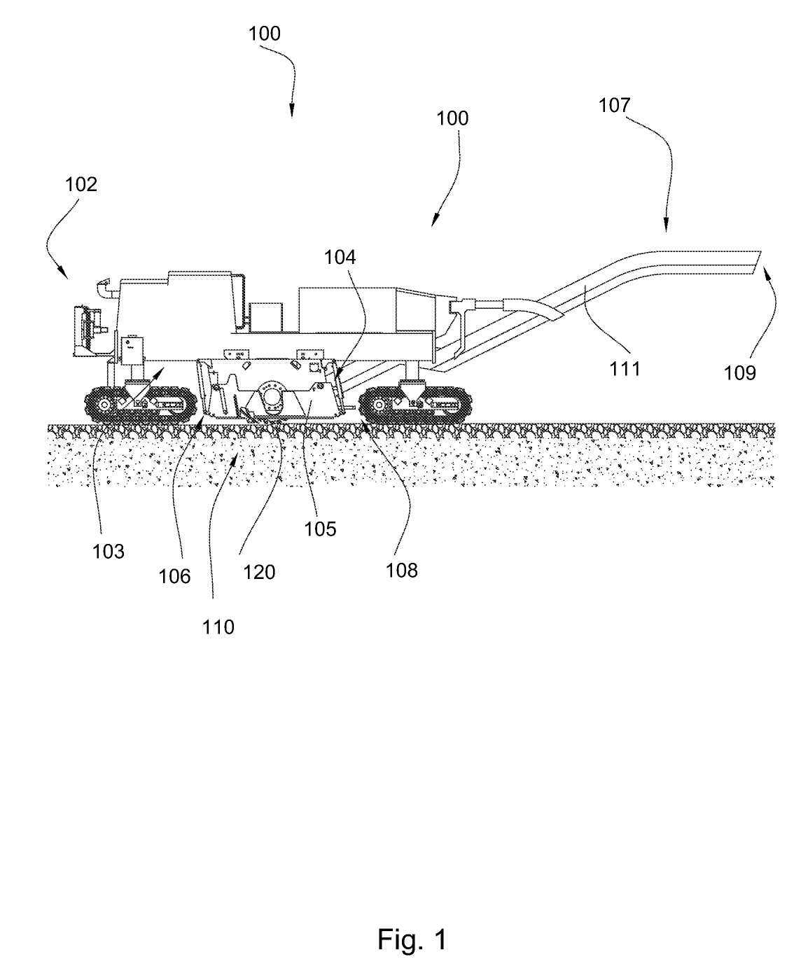

FIG. 1 discloses an embodiment of a self propelled vehicle 100, such as a milling machine. The vehicle has a forward end 101 and a rearward end 102. A milling chamber 110 is attached to the underside 103 of the vehicle's frame. The chamber is formed by a front plate 104, side plates, 105, and a moldboard 106. The milling chamber 110 encloses a rotary degradation drum 120, which is supported by the side plates. A conveyor 107 is also supported by the vehicle. An intake end 108 of the conveyor enters the milling chamber through an opening formed in the chamber, usually formed in the front plate, but the opening may be formed in any portion of the milling chamber. The drum is configured to drop aggregate onto the conveyor proximate its intake end. The conveyor transports the aggregate from the intake end to the output end 109. In the preferred embodiment, the conveyor comprises an enclosure 111 that substantially extends or spans from the intake end to the output end. The enclosure may cover conveyor belts, rollers, gears, and/or other components of the conveyor.

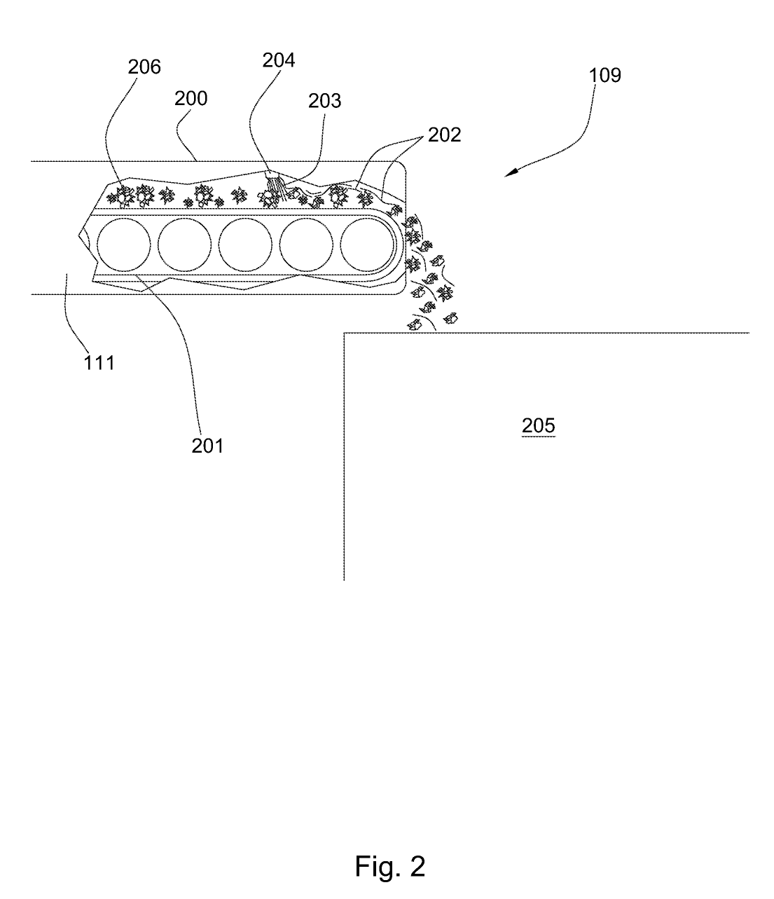

FIG. 2 discloses the output end 109 of the conveyor with a portion of the enclosure 111 removed for illustrative purposes. The conveyor may comprise at least one dust suppressant nozzle configured to apply a dust suppressant to the aggregate 206 carried by the conveyor. In this embodiment, the nozzle is supported by the topside 200 of the enclosure. The nozzle 204 may be positioned above or the side of a conveyor belt 201 carrying aggregate.

The nozzle may spray, fog, and/or foam a dust suppressant onto the aggregate. The dust suppressant may comprise liquid, oil, surfactants, gas, or other compounds that suppress the dust. Fogging the dust suppressant may minimize dust more than spraying a dust suppressant because fogged particles are smaller than spray particles. Larger water particles tend to displace more air as they travel, and this displacement tends to move some dust away from the spray particles. As the air is displaced, airborne dust (or in some cases settled dust) is induced to move; as a consequence, the spray particles may stir up dust. Thus, fogged particles are more efficient as a dust suppressant because fogged particles displace less air and come into contact with the airborne dust easier.

However, in the preferred embodiment, the dust suppressant is foamed. The dust suppressant may be mixed with air under pressure prior to ejection from the nozzle. The mixture of air and dust suppressant may depressurize as the dust suppressant and the air move from the pressurized environment prior to ejection from the nozzle, into the atmospheric pressure after ejection. This depressurization may cause the mixture to expand forming a foam 203. The foam may form a blanket 202 over the aggregate, thereby, forming a layer impermeable to dust. The foam blanket may travel with the aggregate as it is carried by the conveyor and mix with the aggregate while the aggregate and foam are dumped into a truck bed 205. Dust may be further minimized by the dust absorbing moisture from the foam, thereby, adding too much weight to the dust to go airborne.

In some embodiments, the foam has a half life long enough to last the duration between the foaming of the dust suppressant and the aggregate's ejection from the conveyor's output end. However, in some embodiments, the half life is at least twice that duration. Preferably, the half life is long enough to keep the dust suppressed while the aggregate is transported by the conveyor and while the aggregate settles in the truck bed. In some embodiments, the half life will allow the foam to minimize dust after the truck leaves the construction site, thereby, minimizing dust while the aggregate is transported in the truck.

Water may be at least part of a preferred dust suppressant because water easily evaporates without adding an environmental hazard on the aggregate. The foaming process may also minimize the amount dust suppressant required to keep dust down. The characteristics of the foaming nozzle may cause the foam to be light weight, such that the foam does not stir up dust, like spraying large particles into the aggregate.

Foaming nozzles may also be configured evenly distribute the dust suppressant. Spray nozzles tend to distribute fluids unevenly with larger fluid concentrations in the locations were the spray nozzle is directed; therefore, more fluid is required to suppress all the dust. Foaming nozzles of the present invention may be configured to cause the foam to expand in all directions as it exits the nozzle. This expansion may distribute the dust suppressant more evenly over a wider area and thereby minimize pools of dust suppressant in the aggregate.

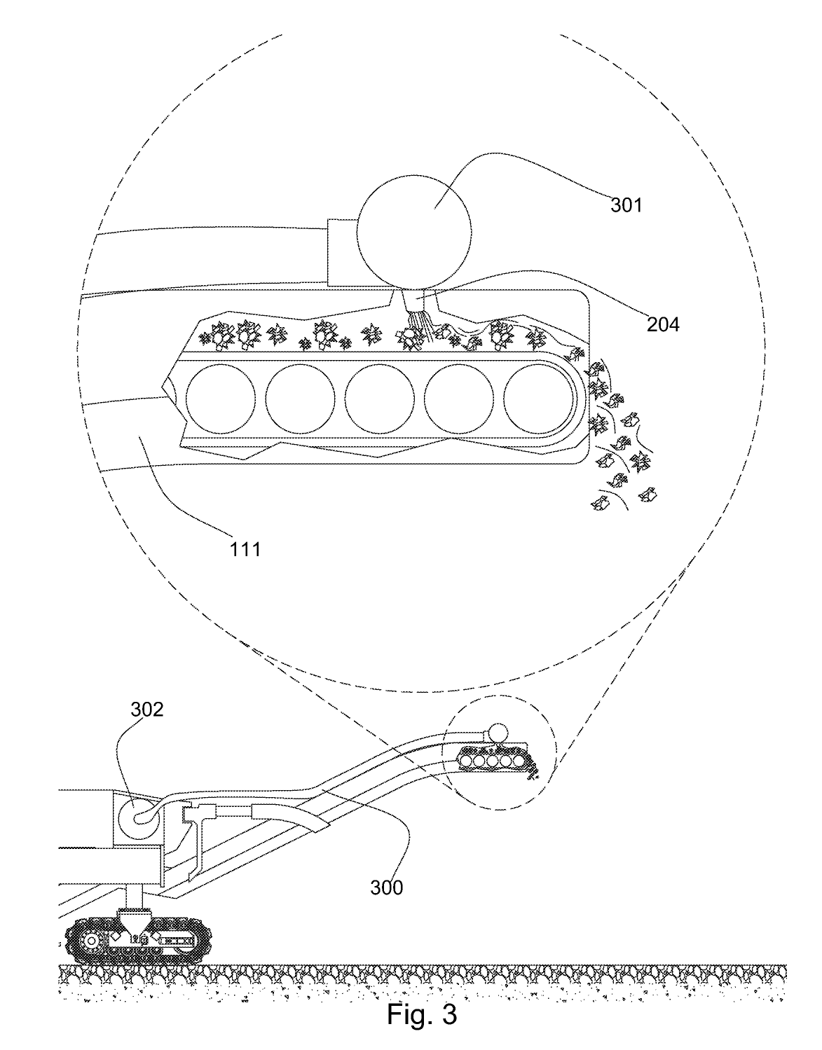

FIG. 3 discloses an air compressor 301 attached to the enclosure 111. The air compressor may be used to cause the dust suppressant and air to mix prior to the dust suppressant's ejection from the nozzle 204. The dust suppressant tank 302 may be secured to the vehicle and be in fluid communication with the air compressor and nozzle through a fluid line 300.

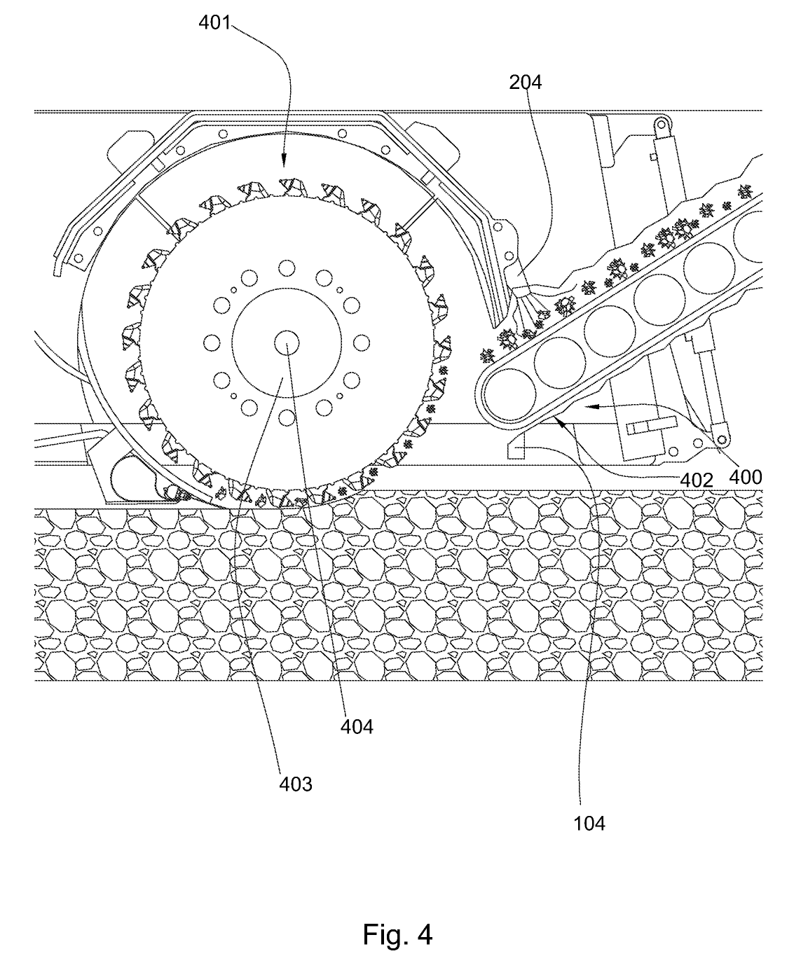

FIG. 4 discloses a nozzle 204 positioned proximate the intake end 400 of the conveyor. The intake end protrudes into the milling chamber 401 through an opening 402 formed in the front plate 104 of the milling chamber. The axle 404 of the drum 403 is supported by the side plates shown in FIG. 1. Dust may also be generated by the milling action within the chamber; therefore, applying the dust suppressant as the aggregate leaves the milling chamber may be most effective. However, in some embodiments, the dust suppressant may be applied to the aggregate at multiple positions along the conveyor, such as proximate the intake end, proximate the output end, and multiple points there between.

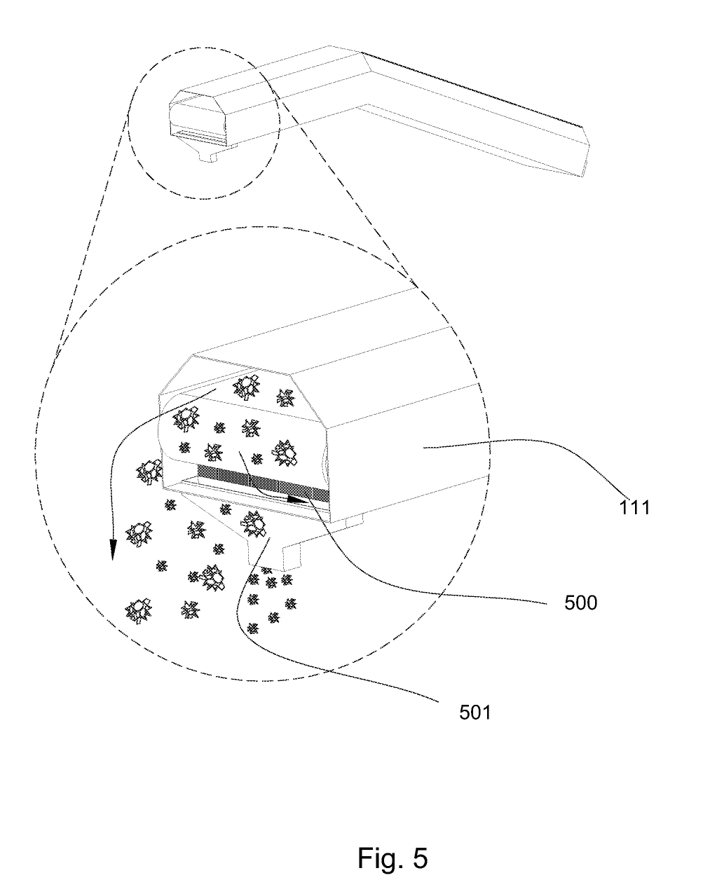

FIG. 5 discloses a brush 500 and vacuum port 501 connected to the conveyor's enclosure 111. The brush may be configured to contact the underside of a conveyor belt to knock off aggregate or dust continuing with the belt. The brush may be a scraper, bristle brush, rotary brush, or combination thereof. The vacuum port may be configured to suck in dust that could otherwise diffuse through the atmosphere and create environmental and/or health problems. A vacuum source, such as a vacuum motor, may direct the suctioned dust directly into a truck bed or back into the conveyor.

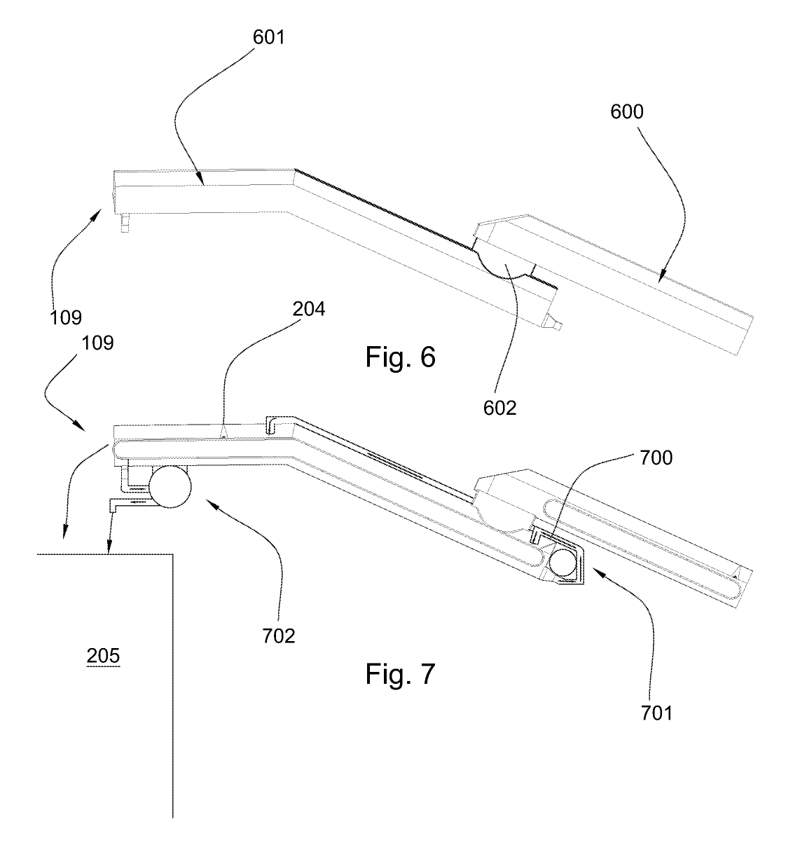

FIG. 6 discloses a conveyor with at least an intake belt 600 and an output belt 601. The belts 600, 601 may be connected by a funnel 602 that directs aggregate from the intake belt to the output belt. While a vacuum port is only shown proximate the output end 109 and a bottom end 603 of the output belt, vacuum ports may be incorporated into the enclosure and/or conveyor where desired.

FIG. 7 discloses a cross sectional view of the embodiment of FIG. 6. Here, the dust guard 700, such as a weld plate, is attached within the enclosure of the output belt proximate the funnel. The guard 700 is configured to prevent aggregate and/or dust from getting underneath the output belt within the enclosure. However, in the event that dust does get behind the guard, a rearward vacuum mechanism 701 may remove the dust and redirect it back onto the output belt. Also, a forward vacuum mechanism 702 may be positioned at the output end 109 of the conveyor. This mechanism 702 may be configured to route removed dust directly into a truck bed 205. A dust suppressant nozzle 204 may be configured within the enclosure to apply dust suppressant to the aggregate as the aggregate is transported to the output end.

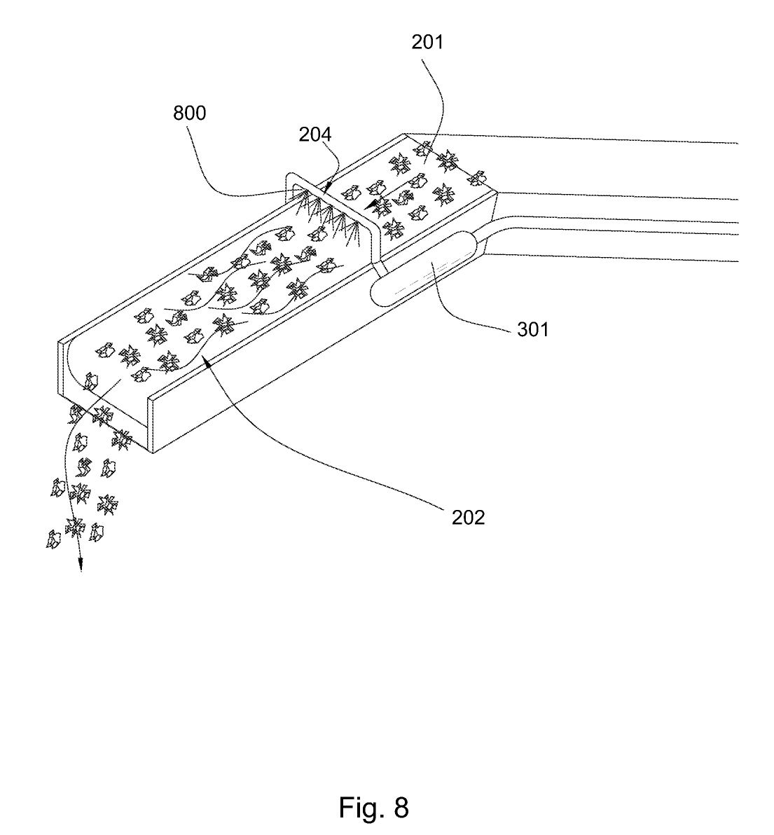

FIG. 8 discloses another embodiment of a conveyor without an enclosure. The nozzle 204 may be disposed to the side and/or over a conveyor belt 201 or other conveying mechanism. An air compressor 301 and/or dust suppressant tank may be attached to the side of the conveyor. In some embodiments, the dust suppressant tank is disposed on the frame of the vehicle and in fluid communication with the air compressor as shown in this embodiment. However, the dust suppressant tank may be in direct fluid communication with the nozzle(s).

The nozzle(s) may be supported by a cross arm 800 that spans the width of the belt or other conveying mechanism. The nozzle may be configured to apply the dust suppressant across the entire width of the belt, thereby, forming a blanket 202 or covering over the aggregate. The nozzles may be straight jet nozzles or fan nozzles. In embodiments that use foam, the foam may be configured to expand rapidly enough to cover at least a significant width of the belt or other conveying mechanism.

While the invention has been described with particular relevance to road milling applications, the dust suppressant may be applied in other applications that use conveyors, such as mining, trenching, excavating, quarrying, or combination thereof. Other conveying mechanism may include augers.

Whereas the present invention has been described in particular relation to the drawings attached hereto, it should be understood that other and further modifications apart from those shown or suggested herein, may be made within the scope and spirit of the present invention.

What is claimed is:

1. An aggregate removal system, comprising:
a self propelled vehicle comprising a frame and a conveyor;
the conveyor comprises an intake end and an output end;
a milling drum is connected to an underside of the frame and is enclosed within a milling chamber, the milling chamber is defined by a front plate, side plates, and a moldboard;
the drum is configured to drop aggregate within the milling chamber onto the intake end of the conveyor that protrudes into the milling chamber;
the conveyor is configured to remove the aggregate from the milling chamber; and
the conveyor comprises at least one dust suppressant nozzle configured to apply a dust suppressant to aggregate carried by the conveyor.

2. The system of claim 1, wherein the conveyor comprises an enclosure that approximately extends from the intake end to the output end.

3. The system of claim 2, wherein the nozzle is incorporated into the enclosure.

4. The system of claim 2, wherein the enclosure also comprises at least one vacuum port configured to remove dust from within the enclosure.

5. The system of claim 4, wherein the vacuum port is attached to a vacuum mechanism configured to direct dust back onto the conveyor.

6. The system of claim 4, wherein the vacuum port is attached to a vacuum mechanism configured to direct dust directly into a truck bed.

7. The system of claim 2, wherein the enclosure comprises a brush proximate the output end and is configure to direct aggregate off an underside of a conveyor belt.

8. The system of claim 1, wherein the nozzle is a spray nozzle that is configured to spray the dust suppressant onto aggregate carried by the conveyor.

9. The system of claim 1, wherein the nozzle is a foaming nozzle that is configured to foam the dust suppressant onto aggregate carried by the conveyor.

10. The system of claim 9, wherein an air compressor is attached to the conveyor and is configured to mix air with the dust suppressant to form a foam before the dust suppressant exists the nozzle.

11. The system of claim 9, wherein the foam comprises a dust suppressing blanket over the aggregate.

12. The system of claim 1, wherein the nozzle is a fogging nozzle that is configured to fog the dust suppressant onto aggregate carried by the conveyor.

13. The system of claim 1, wherein the conveyor comprises a plurality of conveyor belts.

14. The system of claim 1, wherein the intake end of the conveyor is supported by the vehicle, and the output end is suspended in the air.

15. The system of claim 1, wherein the dust suppressant comprises a half life that is at least as long as a duration between applying the dust suppressant to a piece of aggregate and ejecting the piece from the conveyor through the output end.

16. The system of claim 15, wherein the half life is at least twice as long as the duration.

17. The system of claim 1, wherein the at least one dust suppressant nozzle is disposed proximate the intake end.

18. The system of claim 1, wherein the at least one dust suppressant nozzle is disposed proximate the output end.

19. The system of claim 1, wherein the nozzle is supported by a cross arm that spans a width of a conveyor belt.
